(19) United States
(12) Patent Application Publication
(10) Pub. No.: US 2006/0075456 A1
(43) Pub. Date: Apr. 6, 2006

(54) Methods and systems for collaborative capture of television viewer generated clickstreams

(76) Inventors: James Harold Gray, Ellijay, GA (US); Thomas Jefferson Brothers, Gainesville, GA (US)

Correspondence Address: SCOTT P. ZIMMERMAN, PLLC, PO BOX 3822, CARY, NC, 27519, US

(21) Appl. No.: 11/262,329

(22) Filed: Oct. 28, 2005

Related U.S. Application Data
(63) Continuation-in-part of application No. 11/154,248, filed on Jun. 16, 2005.
Application No. 11/154,248 is a continuation of application No. 09/496,825, filed on Feb. 1, 2000, now Pat. No. 6,983,478.
Application No. 09/496,825 is a continuation of application No. 08/779,306, filed on Jan. 6, 1997, now abandoned.
(63) Continuation of application No. 10/735,309, filed on Dec. 12, 2003.

(51) Int. Cl. H04N 7/173; H04N 7/16; H04N 5/445; G06F 13/00; G06F 3/00

(52) U.S. Cl. 725/135; 725/120; 725/37; 725/142

(57) ABSTRACT

Methods and systems provide clickstream captures at both local and remote components by receiving user commands generated by the viewer locally where at least some of those commands are then sent to the remote component concurrently relative to when they are generated by the viewer. Commands may be captured and stored locally while the commands that are sent to the remote component are captured and then stored remotely from the premises of the viewer. Additionally, the user commands may be executed locally such as at a viewer appliance and/or remotely such as at a video control system of a television network. Information related to these user commands continues to be stored locally and/or remotely from the premises of the viewer after the user commands have been executed. Thus, the information related to these user commands can be processed as necessary and used for various purposes.

### CROSS-REFERENCE TO RELATED APPLICATIONS

This application is a continuation-in-part of U.S. patent application Ser. No. 11/154,248, by Grauch et al., filed Jun. 16, 2005 (Attorney Docket BS95003 CON 2), which is itself a continuation of U.S. patent application Ser. No. 09/496,825, by Grauch et al., filed Feb. 1, 2000 (Attorney Docket BS95003 CON), and now issued as U.S. Pat. No. ______, which is itself a continuation of U.S. patent application Ser. No. 08/779,306, by Batten et al., filed Jan. 6, 1997 (Attorney Docket BS95003) (now abandoned), with each incorporated herein by reference in their entirety. This application is also a continuation of U.S. application Ser. No. 10/735,309, filed Dec. 12, 2003 and entitled “Methods and Systems For Collaborative Capture of Television Viewer Generated Clickstreams” (BS02280), and incorporated herein by reference in its entirety.

### BACKGROUND

The exemplary embodiments generally relate to the capture of clickstreams generated by television viewers when making television programming selections. The exemplary embodiments, more particularly, relate to collaborative capture of clickstreams both locally and remotely.

When a television viewer watches television, the viewer periodically makes selections to control what is being viewed. The viewer may change to a different channel and program, may choose to channel surf during commercials, may choose to shut down the television equipment and not watch any programming during certain time periods, etc. The sequence of these user commands are known as a clickstream which provides an indication of what the viewer is or is not watching on television when the clickstream is captured in relation to time, current channel before a change, current channel after a change, etc.

Initially, this clickstream was not captured in any way. The behavior of the television viewer was not tracked, and there was no way to identify trends in the behavior of the television viewer without requiring the television viewer to become involved, such as manually recording what the viewer watches or installing special equipment in the home of the viewer specifically for the purpose of tracking what programs the viewer watched.

The introduction of set top boxes that tune in broadcasted channels for the viewer gave rise to a way to track the television watching behavior of the viewer without requiring the viewer to become involved. The set top box receives multiple streams of television programming and executes the commands from the viewer such as channel changes to control which stream is being viewed by the viewer. The set top box may also be provided with clickstream capture functionality so that when the set top box receives a user command, the command, is captured and stored within the set top box in addition to being executed within the set top box. In this way, the set top box effectively captures the viewing behaviors of the viewer.

The clickstream that has been captured may then be periodically forwarded from the set top box to a service provider system where it can be put to use. The service provider system may process the clickstream relative to profile information of the viewers producing the clickstreams to produce statistics about television viewing habits, such as statistics based on demographics. The service provider and/or television content providers may then utilize these statistics for various purposes. For instance, this information may be used to determine what television programming to provide to consumers.

While this set top box approach does provide the clickstream capture, it has drawbacks because for advanced television networks, some controls such as the switching between streams of programming may be performed within the television network for a viewer rather than at the set top box such that the set top box only receives a single stream at a time. Thus, the set top box may not include the intelligence to recognize the significance of one user command from another but instead simply transfers the user command to the television network for execution such that the set top box is ineffective at capturing the clickstream for these events.

### SUMMARY

The exemplary embodiments provide systems, methods, products, and devices for collaborative clickstream capture. At least some user commands are transferred from the premises of the viewer, such as by a set top box, to a remotely located component such as a video control system within a television network. These user commands are captured at the remotely located component and are stored remotely from the premises of the viewer. Additionally, the set top box continues to capture and store user commands as well, such as user commands that are implemented at the set top box rather than those transferred to the network.

Exemplary embodiments include a method of capturing user commands related to viewing television programming. The method involves receiving a first user command at a viewer appliance at a premises of the viewer and subsequently receiving a second user command at the first component. Information related to the first user command is stored at the viewer appliance concurrently relative to receiving the first user command. Relative to receiving the second user command, the second user command is concurrently forwarded from the viewer appliance to a component located remotely from the premises of the viewer. Information related to the second user command is stored remotely from the premises of the viewer upon receiving the second user command at the component.

Another exemplary embodiment is a method of capturing user commands related to viewing television programming. The method involves receiving a first user command at a viewer appliance at a premise of the viewer and subsequently receiving a second user command at the viewer appliance. Information related to the first user command is stored at the viewer appliance concurrently relative to receiving the first user command. The first user command is executed at the viewer appliance to alter a first aspect of the television programming being viewed by the viewer while the information related to the first user command continues to be stored at the viewer appliance. The second user command is forwarded concurrently relative to receiving the second user command from the viewer appliance to a component located remotely from the premises of the viewer. The second user command is executed at the component to alter a second aspect of the television programming being viewed by the viewer. Information related to the second user command continues to be stored upon receiving the second user command at the component after the second user command has been executed by the second component.

Other exemplary embodiments include a system for capturing user commands related to viewing television programming. The system includes a reception mechanism located at a premise of a viewer for receiving a first and a second user command. A transfer mechanism is located at the premises of the viewer for transferring the second user command concurrently relative to the reception mechanism receiving the second user command. A control mechanism executes the first and second user commands received by the reception mechanism to control aspects of the television programming being provided to the viewer. A capture mechanism is located remotely from the premises of the viewer and receives the second user command being transferred concurrently by the transfer mechanism. A first storage mechanism is located at the premises of the viewer and continues to store information related to the first user command after the first user command has been executed by the control mechanism. A second storage mechanism is located remotely from the premises of the viewer and continues to store information related to the second user command after the second user command has been executed by the control mechanism and received by the capture mechanism.

Another exemplary embodiment is a method of capturing user commands from a viewer that are related to viewing television programming. The method involves receiving the user command at a viewer appliance at the premises of the user. Upon receiving the user command, it is determined whether to store information related to the user command at the viewer appliance and the information related to the user command is stored at the viewer appliance when it is determined that the information related to the user command is to be stored at the viewer appliance. When it is determined not to store the information related to the user command at the viewer appliance, then the user command is forwarded from the viewer appliance.

Still more exemplary embodiments describe a method of capturing user commands from a viewer that are related to viewing television programming. The method involves receiving the user command at a viewer appliance at the premises of the viewer. Upon receiving the user command, it is determined whether to store information related to the user command at the viewer appliance and the information related to the user command is stored at the viewer appliance when it is determined that the user command is to be stored at the viewer appliance. Upon receiving the user command, it is determined whether to execute the user command at the viewer appliance and the user command is executed at the viewer appliance when it is determined that the user command is to be executed at the viewer appliance. When it is determined not to execute the user command at the viewer appliance, then the user command is forwarded from the viewer appliance.

Yet even more exemplary embodiments describe a method of capturing user commands from a viewer that are related to viewing television programming. The method involves receiving the user command at a component remotely from the premises of the viewer. Upon receiving the user command, it is determined whether to store information related to the user command remotely from the premises of the viewer- and the information related to user command is stored remotely from the premises of the viewer when it is determined that the user command is to be stored remotely from the premises of the viewer. The user command is executed at the component.

More exemplary embodiments include a method of capturing user commands from a viewer that are related to viewing television programming. The method involves receiving the user command at a component remotely from the premises of the viewer. Upon receiving the user command, the information related to the user command is stored remotely from the premises of the viewer. Upon receiving the user command, it is determined whether to execute the user command at the component and the user command is executed at the component when it is determined that the user command is to be executed at the component.

### DESCRIPTION OF THE DRAWINGS

These and other features, aspects, and advantages are better understood when the following Detailed Description is read with reference to the accompanying drawings, wherein:

FIG. 1 shows an illustrative clickstream capture system architecture, according to exemplary embodiments;

FIG. 2 shows an illustrative set of logical operations within the system of FIG. 1, according to exemplary embodiments;

FIG. 3 shows an illustrative clickstream capture system architecture according to more exemplary embodiments where a television network executes user commands while some clickstream capture is performed locally and other clickstream capture is performed remotely from the viewer premises;

FIG. 4 shows an illustrative set of logical operations within the system of FIG. 3, according to more exemplary embodiments, where some clickstream capture occurs locally and some occurs remotely and user commands are executed remotely;

FIG. 5 shows an illustrative set of logical operations within the system of FIG. 3, according to yet more exemplary embodiments, where clickstream capture is performed locally and remotely and some user commands are executed locally and some are executed remotely;

FIG. 6 shows an illustrative set of logical operations within the system of FIGS. 1 and 3, according to even more exemplary embodiments, where all clickstream capture occurs both locally and remotely and execution of user commands occurs locally;

FIG. 7 shows an illustrative set of logical operations within the system of FIG. 3, according to still more exemplary embodiments, where all clickstream capture occurs both locally and remotely and execution of user commands occurs remotely; and

FIG. 8 shows an illustrative set of logical operations within the system of FIG. 3, according to yet more exemplary embodiments, where all clickstream capture occurs both locally and remotely and execution of some user commands occurs locally and execution of some user commands occurs remotely.

### DETAILED DESCRIPTION

Exemplary embodiments provide for the collaborative capture of clickstreams that are generated by TV viewers. With clickstream capture occurring at a remote location such as within the television network while clickstream capture is also occurring at the premises of the viewer, those user commands executed either locally or at the remote location may be captured. Furthermore, redundant clickstream capture may also be provided, such as for delivery of the captured clickstream from the local viewer appliance or other device to remote external locations.

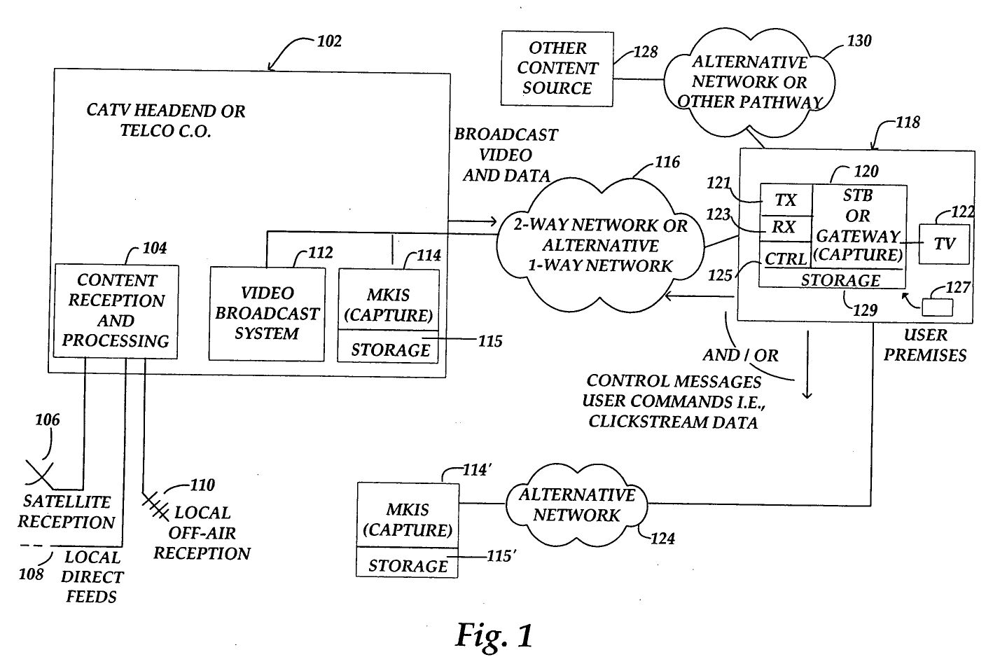

FIG. 1 shows one example of a system for capturing the clickstreams where the television programming that is being provided to the viewer is a broadcast system. Multiple channels of television programming are being broadcast simultaneously to the viewer appliance, which then tunes to the particular channel of programming that the viewer desires to watch. The broadcast television programming is provided to viewers from a central location 102, such as a community access television (“CATV”) headend or a telephone company (“telco”) central office (“CO”) which may provide Internet connectivity for streaming programming to the viewer.

The central location 102 includes various components for receiving the television programming to be broadcast to the television viewers. Much of the television programming originates from a satellite reception via a satellite receiver dish 106. Additional direct local feeds 108 receive direct transmission via a wireline link to local television stations. Also, additional local off-air reception via antennas 110 may also receive local programming that is not otherwise received through the direct local feeds 108.

These programming sources provide received programming to a content reception and processing system 104. This system 104 takes the various channels of television programming being received and creates a channel line-up. The channel line-up is the distribution of the channels being provided by the service provider over the particular channels designated by the service provider. The content reception and processing system 104 receives a particular stream of programming and assigns it to a particular channel within the channel line-up.

The content reception and processing system 104 provides the individual streams of programming to a video broadcast system 112. The video broadcast system 112 then broadcasts each of the streams of programming within its assigned channel of the channel line-up. The video broadcast system 112 broadcasts these channels, as well as data such as guide data, over a distribution network 116 that feeds each of a plurality of individual television viewer premises 118. Typically, the distribution network 116 includes a network of coaxial or other lines that extend over a region being served, where each of the lines terminates at viewer premises 118.

The broadcasts may be either in an analog or a digital format. The network 116 may carry either format or both formats, such as where one set of channels of the channel line-up are broadcast as analog while another set of channels of the channel line-up are digital. Additionally, the network 116 may carry two-way communications such that communications may be provided back to the central location 102 from viewer premises 118. Alternatively, the network 116 may carry only one-way communications from the central location 102 to viewer premises 118.

In addition, there may be alternative sources of television programming to a viewer appliance 120 at viewer premises 118. An alternative source of content 128 may be provided to the viewer through an alternative network 130 such as a digital satellite connection, a digital off-air reception, etc. Thus, the viewer may select from various sources of content when providing user commands, and these user commands are captured for later processing.

At viewer premises 118, the incoming stream of channels is provided to the viewer appliance 120. The viewer appliance 120 such as a set top box or broadband gateway allows a viewer to provide commands to control aspects of the television programming being viewed, such as channel changes and/or additional aspects such as audio format and volume control. The viewer appliance typically outputs the selected channel to a television 122. The viewer appliance 120 may be a gateway in place of a set top box so as to receive user commands from different areas of the premises 118 and distribute the selected channel to televisions located in different areas as opposed to having a viewer appliance 120 at each location where a television 122 is present. It should be appreciated that the viewer appliance 120 may be incorporated into the television 122 rather than being a separate component.

When a viewer is watching television, the viewer provides user commands to control the aspects of television programming as desired. The viewer may provide a user command by pressing buttons on a remote control 127 that provides a corresponding signal to the viewer appliance 120 that is received by a reception module 123. Alternatively, the viewer may provide a user command by pressing buttons located on the viewer appliance 120 itself. The viewer appliance 120 executes the command through a control module 125 to control the television programming as desired by the viewer. In addition to executing the command, as the command is received the viewer appliance 120, the user command (i.e., a control message) may be captured and stored at the viewer appliance in storage 129 and/or the user command may be forwarded to an external location by a transfer module 121.

For example, user commands relative to the television programming may be forwarded back to the central location 102 for capture and storage. The viewer appliance 120 may also capture and store these commands for redundancy. Furthermore, user commands relative to the television programming coming from the alternative network 130 may be captured and stored in the viewer appliance 120 if the alternative network 130 is a one-way network and/or the alternative content source 128 lacks the ability to capture and store user commands.

For user commands that are captured and stored within the viewer appliance 120, the commands may be stored with a time stamp as to when they are received and may also be stored with additional information such as the end result of execution of the command, e.g., “on channel 3.” These clickstream captures are held until a pre-determined time, and at that time, the set of clickstream data that has been captured and stored over the preceding period is then transferred as a data set back to a marketing information system (“MKIS”) 114. The MKIS 114 is interfaced to the two-way network 116 such that user commands are directed to the MKIS 114 where they are stored in storage 115 of the MKIS 114 and are matched with the viewer profile information for the viewer who sent the user command. As discussed below, matching the user command data at the MKIS 114 allows for additional downstream processing to occur that enables statistics such as those based on demographics to be determined about television viewing behaviors.

Rather than forwarding the captured set of clickstream data back to the central location 102 through the distribution network 116, the viewer appliance 120 may be provided an alternative route to forward the captured set of clickstream data. For example, the distribution network 116 may only be a one-way network or the destination for the user commands may be other than the central location 102. Thus, the viewer appliance 120 may be provided with a connection to an alternative data network 124 which interconnects an MKIS 114′ to the viewer appliance 120. For example, the viewer appliance 120 may be connected to a digital subscriber line (“DSL”) or other broadband connection, a public switched telephone network (“PSTN”), wireless, etc., that leads to the network 124. Thus, when the time comes for the viewer appliance 120 to forward the stored set of clickstream data, it is forwarded through the alternative network 124 to the MKIS 114′ where it is stored in storage 115′ and matched with viewer profile information.

For user commands that are captured remotely, the viewer appliance 120 may forward the user commands as they are received to an external location in various ways. For example, where the distribution network 116 is a two-way network, the user command may be transferred over the network 116 back to the central location 102. The destination for the user command in this example is the MKIS 114.

Typically, the MKIS 114 stores the user commands coming from a particular viewer premises 118 in association with an identifier of the viewer such that the MKIS 114 matches the user command to a profile for the viewer, such as the demographical categories of the viewer. Also, the MKIS knows the context in which the user command is received due to the MKIS 114 storing a time stamp for when the user command is received and also having stored the preceding user commands. Accordingly, downstream processing can determine behaviors of TV viewers relative to the content being provided based on knowing when a user command or stream of user commands (i.e., a clickstream) is received relative to what content is being shown on a particular channel at that particular time. Thus, one can determine that a television viewer switches from one program to another, switches the channel during commercials, mutes the television when certain content is present, etc. Furthermore, an analyst may match these behaviors statistically with the various demographic categories known for the viewers. This same process is also applicable to the set of clickstream data that has been captured and stored by the viewer appliance 120 that is periodically transferred as a set to the MKIS 114 as discussed above.

Rather than forwarding the user commands as they are received back to the central location 102 through the distribution network 116, the viewer appliance 120 may be provided an alternative route to forward the user commands. For example, the distribution network 116 may only be a one-way network or the destination for the user commands may be other than the central location 102. Thus, the viewer appliance 120 may be provided a connection to an alternative data network 124 which interconnects an MKIS 114′ to the viewer appliance 120. For example, the viewer appliance 120 may be connected to a digital subscriber line (“DSL”) or other broadband connection, through to network 124. Thus, when the viewer appliance 120 receives the user command, it is forwarded through the alternative network 124 to the MKIS 114′ where it is captured from the stream of communication and is stored in storage 115′ as described above.

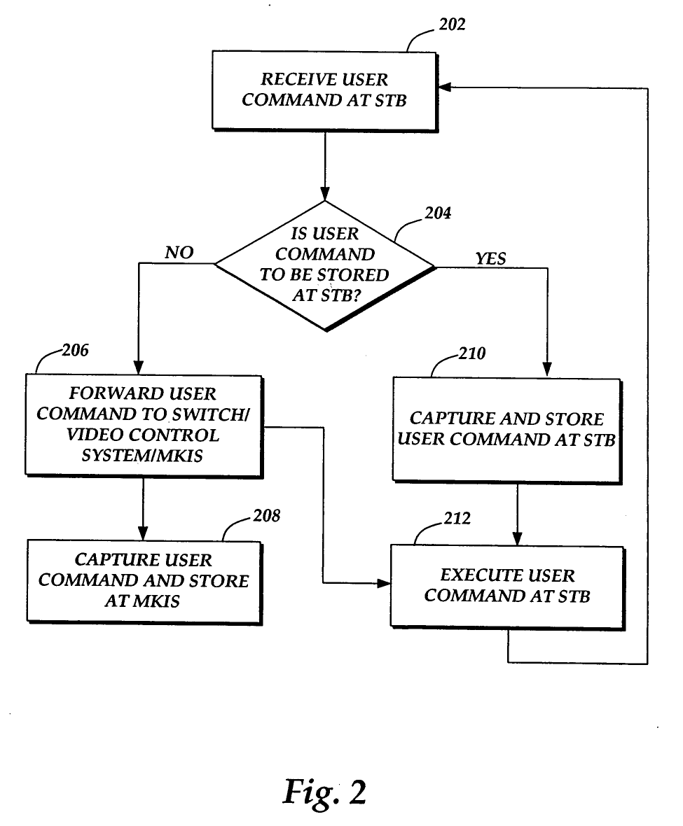

FIG. 2 shows the logical operations performed within the system of FIG. 1 to capture the user commands at a location remote from viewer premises 118, such as at the MKIS 114. Initially, the user command is received at the viewer appliance 120 at reception operation 202. As described above, this may be from the viewer entering a command through a remote control or by entering the command directly on the viewer appliance 120. Then at query operation 204, the viewer appliance 120 detects whether this is a user command that is to be stored at the viewer appliance 120, such as by performing a look-up or as an automatic function of the user command. For example, this may be a user command that is to be stored at both the viewer appliance 120 and in the television network of the central location 102. As another example, this may be a user command relative to an alternative content source 128, where the alternative content source 128 lacks the ability to capture and store the user commands such that the viewer appliance 120 must capture and store them to preserve them for future uses.

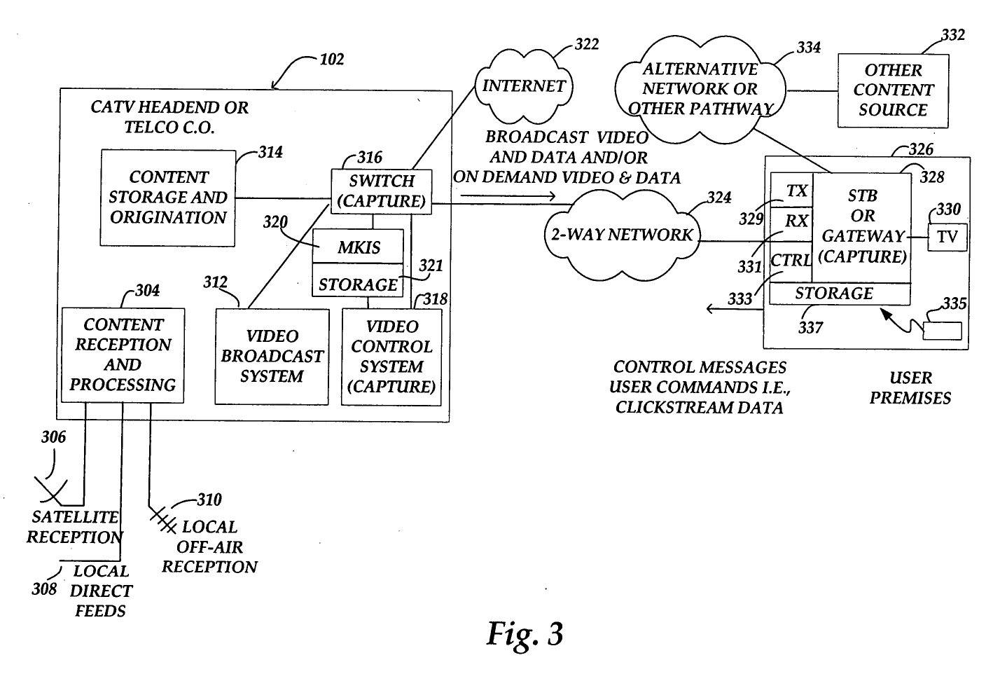

Upon detecting that the user command is not to be stored at the viewer appliance 120, the viewer appliance 120 proceeds by forwarding the user command to the MKIS 114 at forward operation 206. It should be noted that additional discussion of FIG. 2, in particular forward operation 206, will also be provided below with reference to the system of FIG. 3, which introduces a switch 316 and a video control system 318 that may also be relevant to the forward operation 206. Upon the MKIS 114 receiving the forwarded user command information, the user command is captured and stored as appropriate for future processing at capture operation 208. Also upon receiving the user command, the viewer appliance 120 executes the user command to alter the aspects of the television programming at execution operation 212. While forward operation 206 and execution operation 212 are shown to occur in series, it will be appreciated that the viewer appliance 120 may perform these two operations in parallel such that there is no perceived delay by the viewer in entering the command and seeing the result of its execution.

Upon detecting that the user command is to be stored at the viewer appliance 120 at query operation 204, the viewer appliance 120 captures and stores the user command at capture operation 210. The viewer appliance 120 also executes the user command to control the aspect of the television programming as desired by the viewer, such as changing a channel or controlling the volume at execution operation 212. While capture operation 206 and execution operation 212 are also shown to occur in series, it will be appreciated that the viewer appliance 120 may also perform these two operations in parallel such that there is no perceived delay by the viewer in entering the command and seeing the result of its execution.

FIG. 3 shows another example of a system for capturing the clickstreams, but in this example the television programming that is being provided to the viewer includes at least video-on-demand. In the video-on-demand system, the streams of programming to be sent to the viewer are switched within the television network of central location 302 such that only one of the streams is being sent through a network 324 to a viewer appliance 328. The system of FIG. 3 may also but not necessarily include broadcasted programming where multiple streams are being provided to and selected by the viewer appliance 328 as discussed above in relation to FIG. 1. The video-on-demand and broadcast television programming is provided to viewers from a central location 302.

The central location 302 of this example includes various components for receiving the television programming to be provided to the television viewers. Again, much of the television programming originates from a satellite reception via a satellite receiver dish 306. Additional direct local feeds 308 receive direct transmission via a wireline link to local television stations. Also, additional local off-air reception via antennas 310 may also receive local programming that is not otherwise received through the direct local feeds 308.

These programming sources provide received programming to a content reception and processing system 304. This system 304 takes the various channels of television programming being received and creates a channel line-up. The content reception and processing system 304 receives a particular stream of programming and assigns it to a particular channel within the channel line-up.

The content reception and processing system 304 provides the individual streams of programming to a video broadcast system 312. The video broadcast system 312 then broadcasts each of the streams of programming within its assigned channel of the channel line-up. The video broadcast system 312 broadcasts these channels, as well as data such as guide data, to a switch 316 at the central location 302. This switch 316 then switches between the various sources of programming to provide a particular stream of programming through the distribution network 324 to viewer premises 326 according to a selection by a viewer.

In addition to receiving the broadcasted channel line-up from the video broadcast system 312, the switch 316 may receive television programming content from various other sources as well. For example, the switch 316 may receive content from a content storage and origination system 314. The content storage and origination system 314 may provide video-on-demand programming such as movies and other programming that viewers may want to watch at any given time such that content is stored and can be selected for playback to the viewer at any time the viewer requests. Such video-on-demand services are often provided on a fee per use basis or monthly fee basis. The switch 316 may also receive content through the Internet 322 from a source of television programming content and may provide television programming as well as data services to the end viewer through the distribution network 324.

A video control system 318 is included at the central location 302 to provide additional intelligence for operation of the switch 316. The switch 316 receives user commands for the changing from one stream to send to the viewer appliance 328 to another. The switch 316 may select one stream or another, such as those streams from the video broadcast system 312, without further assistance. However, certain channels of the video broadcast system 312 or content from the content and storage origination system 314 may be controlled on an account basis. The video control system 318 verifies that a particular viewer requesting a given channel or content has authorization to receive that channel or content and controls the switch 316 to either provide the channel/content or not provide the channel/content.

The streams being provided to viewer premises 326 may be either in an analog or a digital format. The network 324 may carry either format or both formats, such as where one set of channels of the channel line-up being received by the switch 316 are broadcast as analog while another set of channels of the channel line-up are digital. Additionally, the network 116 carries two-way communications such that communications are provided back to the switch 316 of the central location 302 from viewer premises 326 such that the switch 316 can select the particular stream to provide back through the network 324 to viewer premises 326.

In addition, there may be alternative sources of television programming to the viewer appliance 328 at viewer premises 326. An alternative source of content 332 may be provided to the viewer through an alternative network 334 such as a digital satellite connection, a digital off-air reception, etc. as discussed above in relation to FIG. 1. Thus, the viewer may select from various sources of content when providing user commands, and these user commands are captured for later processing in the system of FIG. 3.

At viewer premises 326, the incoming stream of channels is provided to a viewer appliance 328. The viewer appliance 328 allows a viewer to provide commands to control aspects of the television programming being viewed on the television 330, such as channel changes and/or additional aspects such as audio format and volume control.

When a viewer is watching television, the viewer continues to provide user commands to control the aspects of television programming as desired. Again, the viewer may provide a user command by pressing buttons on a remote control 335 that provides a corresponding signal to the viewer appliance 328 that is received by a reception module 331. Alternatively, the viewer may provide a user command by pressing buttons located on the viewer appliance 328 itself. As the command that is relevant to the content being provided from the central location 302 is received, the viewer appliance 328 forwards the user command (i.e., a control message) back to the switch 316 at the central location 302 through a transfer module 329 rather than merely storing a record of it in storage 337 for future transfer. Where the command is a change to a new stream of programming, then the switch 316 and video control system 318 executes the command to begin providing a different stream, rather than the viewer appliance 328 executing the change. Where the user command is other than a channel change, such as a selection of audio format or volume, then the viewer appliance 328 also executes the command through a control module 333.

For the situation where the user command is not executed within the central location 302, such as for a volume change or for a user command relevant to an alternative source of content 332, then the user command may not be forwarded to the central location 302 since the central location 302 will not execute it. However, to prevent this user command from being lost, the viewer appliance 328 may capture and store this user command along with contextual information such as time received and then at a pre-determined time in storage 337, and subsequently forward the collection of stored user commands to an MKIS 320 such as over the two-way network 324 or over an alternative network interconnected to the same or different MKIS 320.

Once a user command that has been forwarded from the viewer appliance 328 is received at the switch 316, it may be captured by the video control system 318 or the switch 316 from the stream of information being received from the network 324. The MKIS 320 is interfaced to the switch 316 and video control system 318 such that the user command is then passed to the MKIS 320 where it is stored in storage 321 in association with the contextual information that has been matched with the user command at the video control system 318, such as the identifier of the viewer who generated the command, the time at which the viewer appliance 328, switch 316, or video control system 318 received the user command, etc. Additionally, the video control system 318 may also match the user command being forwarded to the MKIS 310 with a result of the user command or may only forward the result. For example, the user command may be a channel up button, whose result is a change from channel 2 to channel 3 such that the video control system 318 forwards an “on channel 3” result to the MKIS 320 for storage.

The viewer appliance 328 may also forward the user command as it received to an external location in other ways. For example, in systems where the MKIS 320 is not interfaced to the switch 316 and/or video control system 318, the MKIS 320 may be accessed through alternative network as described above in relation to FIG. 1. The viewer appliance 328 may be provided a connection to such an alternative data network which interconnects an MKIS 320 to the viewer appliance 328. Like in the example of FIG. 1, the viewer appliance 328 may be connected to a digital subscriber line (“DSL”) or other broadband connection. When the viewer appliance 328 receives the user command, it is forwarded back through the network 324 for execution while it is simultaneously forwarded through the alternative network to the MKIS 320 where it is captured from the stream of communication and is stored as described above.

Returning to FIG. 2, these logical operations may be performed within the system of FIG. 3 for situations where the viewer appliance 328 will execute the user commands and the viewer appliance 328 and/or the central location will capture and store the user commands. For example, the switch 316 of FIG. 3 may pass multiple broadcasted channels to the viewer appliance 328 at a time to allow the viewer appliance 328 to select the particular stream that the viewer is interested in watching. The system may be configured so that the network records such channel changes by the viewer appliance 328, but the viewer appliance 328 records other user commands it executes such as volume changes. In this situation, once the user command is passed to the switch 16 or video control system 318 at forward operation 206, the user command is then passed on to the MKIS 320 for capture and storage at capture operation 208 without the switch 316 or video control system 318 executing the user command which has already been executed in the viewer appliance 328.

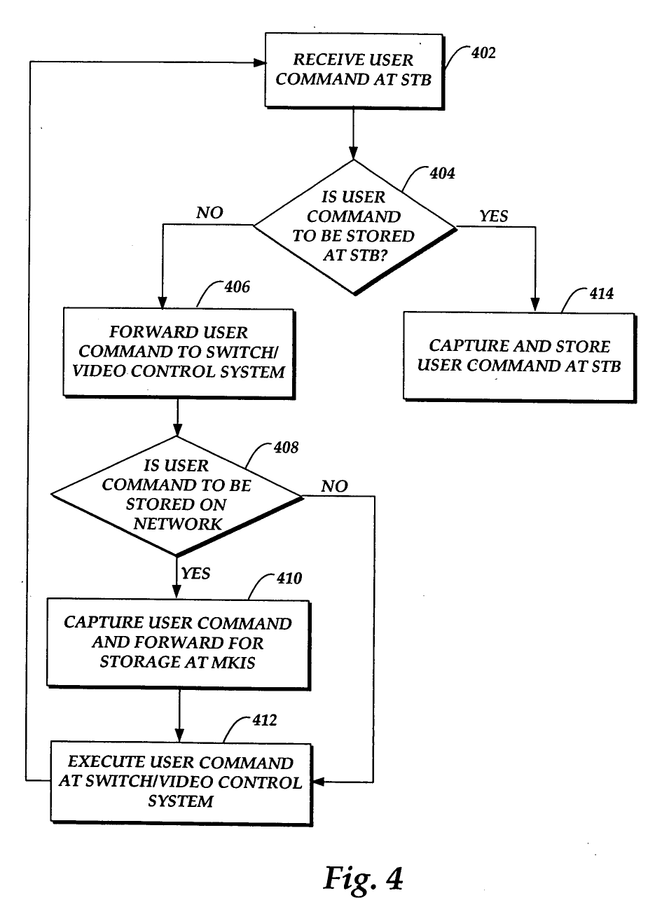

FIG. 4 shows the logical operations that may be performed within the system of FIG. 3 where all user commands being received at the viewer appliance 328 are executed within the television network of the central location 302. The logical operations begin with the viewer appliance 328 receiving the user command at reception operation 402. Then, the viewer appliance 328 detects at query operation 404 whether the viewer appliance 328 is to capture and store this command, such as by a look-up or by an automatic function of the user command. For example, although the central location 302 is going to execute the user command, it may be a less significant user command such that the central location 302 does not capture and store it so that the viewer appliance 328 must capture and store it to preserve it. Alternatively, the central location 302 may also capture and store it but it is desired to capture and store it within the viewer appliance 328 for redundancy.

Upon detecting that the user command is not to be stored at the viewer appliance 328, then the viewer appliance 328 forwards the user command to the switch 316 and video control system 318 at forward operation 406. The switch 316 and video control system 318 then detects at query operation 408 whether the user command is to be captured and stored within the central location 302, again by a look-up or as an automatic function of the user command. Query operation 408 may be complementary to query operation 404 such that those commands captured and stored by the viewer appliance 328 are not stored by the central location 302 but those commands not captured and stored by the viewer appliance 328 are captured and stored by the central location 302. However, the system may be configured otherwise where some of those captured and stored at the viewer appliance 328 are also captured and stored in the central location 302.

Upon detecting that the user command is to be stored on the central location 302, then the user command is captured at the switch 316 or video control system 318 and forwarded for storage to MKIS 320 at capture operation 410. Also, the switch 316 or video control system 318 executes the user command at execution operation 412, either in series or in parallel with capture operation 410. When the viewer appliance 328 detects at query operation 408 that the user command is not to be stored within the central location 302, then operational flow proceeds directly to execution operation 412 where the user command is executed.

Upon the viewer appliance 328 detecting at query operation 404 that the user command is to be stored within the viewer appliance 328, then operational flow proceeds to capture operation 414. Here, the viewer appliance 328 captures and stores the user command, along with the related contextual information such as time of reception. Also, operational flow returns to forward operation 406 where the user command is forwarded to the switch 316 or video control system 318.

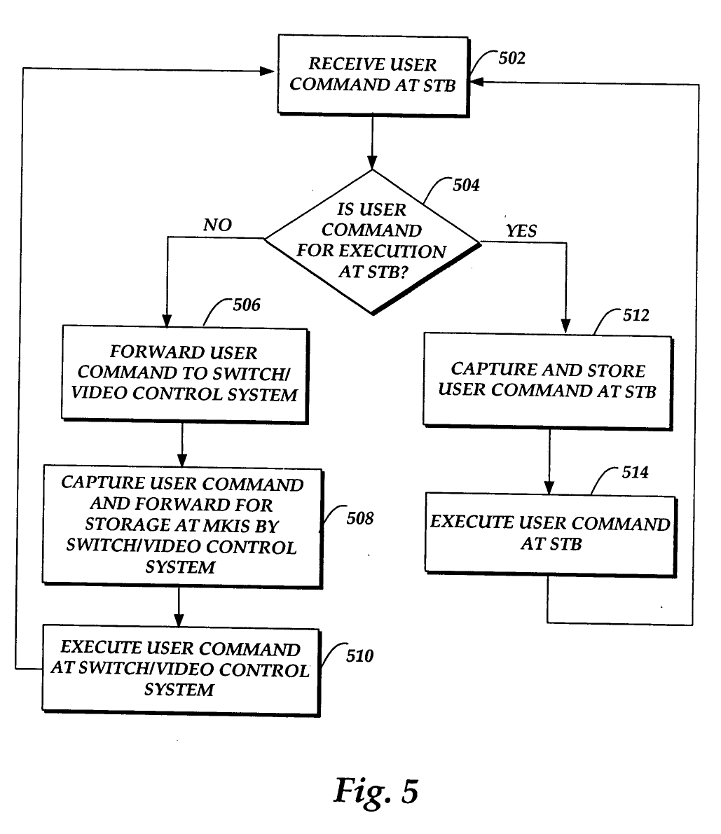

FIG. 5 shows illustrative logical operations for utilizing the capture and store functions of the viewer appliance 328 for user commands that the viewer appliance 328 executes while utilizing the capture and store functions of the central location 302 for user commands that the central location 302 executes within the system of FIG. 3. The logical operations begin at reception operation 502 where the viewer appliance 328 receives the user command. Then, at query operation 504, the viewer appliance 328 detects whether the received command is a command that the viewer appliance 328 executes, such as by a look-up or by an automatic function of the user command. For example, certain channel changes may be executed in the central location 302 while other channel changes or volume changes are executed at the viewer appliance 328.

Upon detecting that the user command is not for execution at the viewer appliance 328, the viewer appliance 328 forwards the user command to the switch 316 or video control system 318 at forward operation 506. The switch 316 or video control system 318 captures the user command and forwards it to the MKIS 320 along with contextual information and/or results of execution at forward operation 508. Also, at execution operation 510, the switch 316 or video control system 318 executes the user command to control an aspect of the television programming such as changing the channel being provided to viewer premises 326. As previously noted with regard to FIG. 4, forward operation 508 and execution operation 510 may be performed in series as shown or may be performed in parallel to eliminate any delay in providing the result of the command to the viewer.

Upon detecting that the user command is for execution at the viewer appliance 328, the viewer appliance 328 captures and stores the user command at capture operation 512. The viewer appliance 328 also executes the user command at execution operation 514, which may be performed in series or in parallel with capture operation 512.

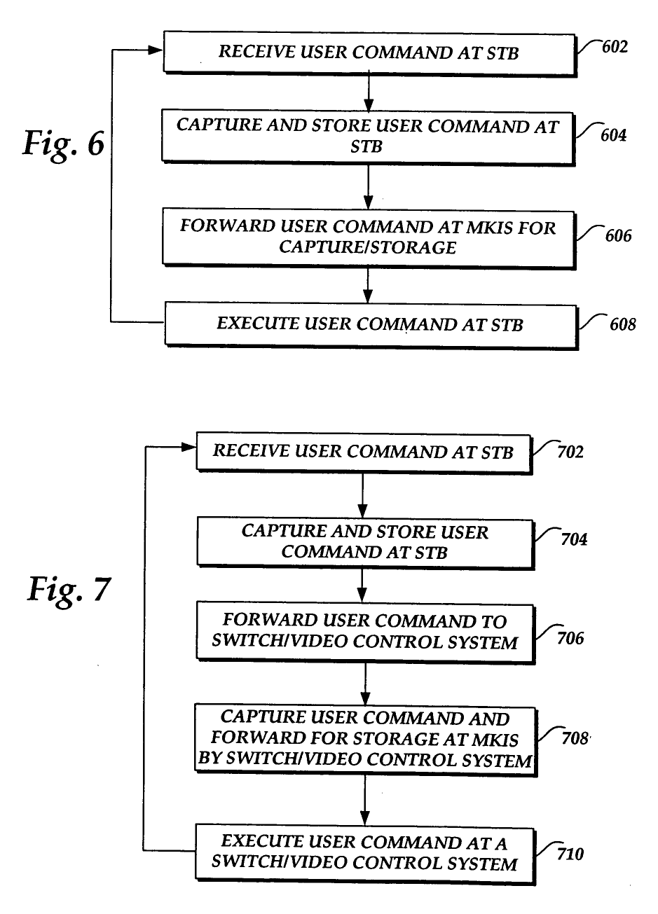

FIG. 6 shows an illustrative set of logical operations that may be performed within the systems of FIG. 1 or FIG. 3. Here, the user commands are all captured and stored at both the viewer appliance 328 and the central location 302, such as for redundancy, and are executed at the viewer appliance 328. The logical operations begin at reception operation 602 where the viewer appliance 328 receives the user command. The viewer appliance 328 then captures and stores the user command at capture operation 604 and forwards the user command to the MKIS 320 for capture and storage at forward operation 606. The viewer appliance 328 also executes the command at execution operation 608 which may be performed in series or in parallel with forward operation 606.

FIG. 7 shows an illustrative set of logical operations that may be performed within the system of FIG. 3. Here, the user commands are all captured and stored at both the viewer appliance 328 and the central location 302, such as for redundancy, and are executed within the central location 302. The logical operations begin at reception operation 702 where the viewer appliance 328 receives the user command. The viewer appliance 328 then captures and stores the user command at capture operation 704 and forwards the user command to the switch 316 or video control system 318 for capture and storage at forward operation 706. The switch 316 or video control system 318 captures the user command and forwards it to the MKIS 320 for storage at capture operation 708. The switch 316 or video control system 318 also executes the command at execution operation 710 which may be performed in series or in parallel with capture operation 708.

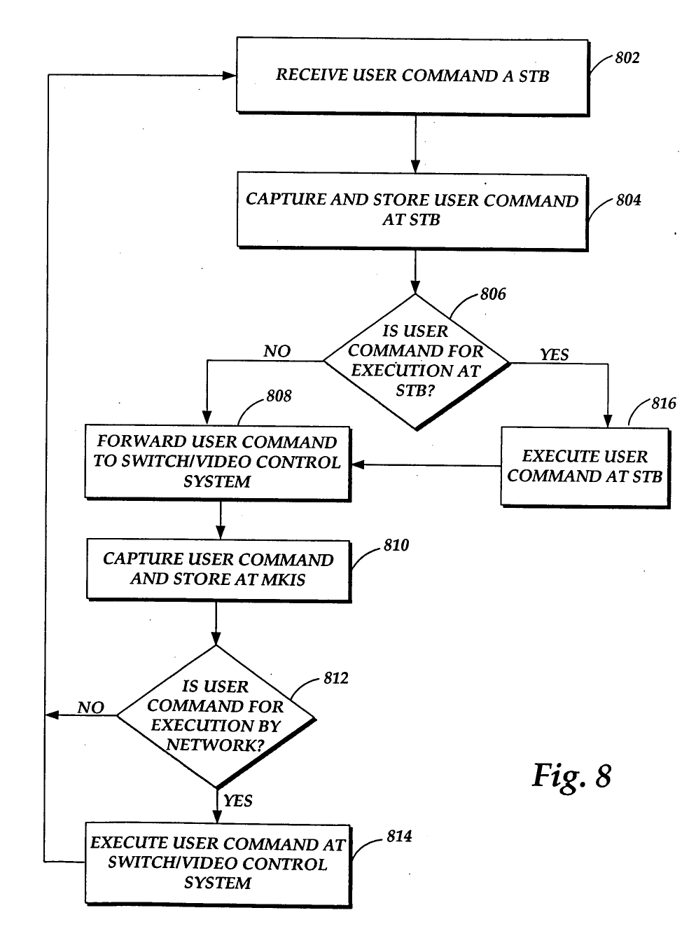

FIG. 8 shows an illustrative set of logical operations that may be performed within the system of FIG. 3. Here, the user commands are all captured and stored at both the viewer appliance 328 and the central location 302, and some of the user commands are executed at the viewer appliance 328 while others are executed within the central location 302. The logical operations begin at reception operation 802 where the viewer appliance 328 receives the user command. The viewer appliance 328 then captures and stores the user command at capture operation 804 and determines at query operation 806 whether the command is for execution at the viewer appliance 328.

Upon detecting that the command is not for execution at the viewer appliance 328, the viewer appliance 328 forwards the user command to the switch 316 or video control system 318 at forward operation 808. The switch 316 or video control system 318 captures the user command and forwards it to the MKIS 320 for storage at capture operation 810. The switch 316 or video control system 318 also detects at query operation 812 whether the user command is for execution by the switch 316 or video control system 318.

Query operation 812 may be complementary to query operation 804 such that those commands not to be executed by the viewer appliance 328 are to be executed by the central location 302 while those commands that are to be executed by the viewer appliance 328 are not to be executed by the central location 302. However, the system may also be configured such that there are user commands that may be executed within the viewer appliance 328 and within the central location 302. For instance, one scenario may be that the central location 302 executes the command by providing a new stream of programming to the viewer appliance 328, and the viewer appliance 328 executes the same user command by changing to a new input or channel to receive the new stream of programming.

Upon the switch 316 or video control system 318 detecting at query operation 812 that the user command is to be executed by the central location 302, then the switch 316 or video control system 318 executes the command at execution operation 814. Upon detecting that the user command is not to be executed by the central location 302, then the process ends with respect to the current user command and waits for the next user command at reception operation 802. While capture operation 810 is shown in series with query operation 812 and execution operation 814, these operations may also be performed in parallel to eliminate any delay in providing the result of execution to the viewer.

When the viewer appliance 328 detects at query operation 806 that the user command is for execution at the viewer appliance 328, then operational flow proceeds to execution operation 816 where the viewer appliance 328 executes the user command. Then, operational flow proceeds to forward operation 808 and continues as described above.

Thus, exemplary embodiments of clickstream capture provide for the collaborative capture and storage of the user command between the viewer appliance and an external location. This eliminates that requirement that the viewer appliance or central location capture and store all user commands, but all user commands may be captured and stored at both locations for redundancy. As an advantage of performing clickstream capture collaboratively between the viewer appliance and an external location, those user commands being executed at one location may be captured and stored there while those commands being executed at another location may be captured and stored there, or some combination. As the external location typically has much greater capacity than an individual viewer appliance, the external location may store all user commands while the user commands to be captured and stored at the viewer appliance are filtered so that only those of significance are stored. For any clickstream capture that occurs at the viewer appliance, the clickstream data set may then be periodically forwarded to a downstream location for processing in conjunction with the clickstream data that has been captured and stored in the central location of the television network or other external location.

The data that has been stored in the MKIS of the embodiments discussed above may then be used for various purposes. It may be used to target advertising for particular times and television programs. It may also be used to determine the proper characteristics for advertisements such as length and content. Furthermore, the data may be used to determine the proper television programming to provide at any given time. Accordingly, the data that is obtained has significant value in relation to making determinations about what content is provided for television viewers. Usage of this data for such purposes is discussed in more detail in U.S. application Ser. No. 09/467,889, filed on Dec. 21, 1999, and entitled METHOD AND SYSTEM FOR PROVIDING TARGETED ADVERTISEMENTS.

Although exemplary embodiments have been described in connection with various illustrative embodiments, those of ordinary skill in the art will understand that many modifications can be made thereto within the scope of the claims that follow. Accordingly, it is not intended that the scope of the exemplary embodiments in any way be limited by the above description, but instead be determined entirely by reference to the claims that follow.

What is claimed is:

1. A method of collecting subscriber commands related to viewing content, comprising:
receiving a first subscriber command having an application identifier corresponding to a particular application to which the first subscriber command is addressed;
concurrently locally storing an event record at a media device, the event record comprising i) the application identifier, ii) an identification code corresponding to the first subscriber command, and iii) a time stamp that records a time of occurrence of the first subscriber command;
subsequently receiving a second subscriber command at the media device; and
concurrently forwarding the second subscriber command from the media device to a component remotely located from the media device.

2. The method of claim 1, further comprising: querying whether the first subscriber command should be locally stored at the media device.

3. The method of claim 2, further comprising forwarding the first subscriber command from the media device to the component remotely located from the media device.

4. The method of claim 1, further comprising querying whether information related to the second subscriber command should be locally stored at the media device.

5. The method of claim 1, further comprising determining a result of the second subscriber command relative to a present context and including the result in the second subscriber command that is forwarded from the media device.

6. The method of claim 1, further comprising concurrently locally storing information related to the second subscriber command at the media device.

7. The method of claim 1, wherein after expiration of a pre-determined period of time, then forwarding information related to the first subscriber command from the media device.

8. The method of claim 1, further comprising receiving targeted advertising based upon information related to the first subscriber command.

9. A device for collecting commands related to viewing content, comprising:
a processor communicating with memory and with an interface, the processor executing instructions stored in the memory,
the interface receiving a first subscriber command having an application identifier, the application identifier corresponding to a particular application to which the first subscriber command is addressed;
the processor concurrently locally storing an event record, the event record comprising i) the application identifier, ii) an identification code corresponding to the first subscriber command, and iii) a time stamp that records a time of occurrence of the first subscriber command;
the interface subsequently receiving a second subscriber command; and
the processor concurrently forwarding the second subscriber command from the device to a remotely located component.

10. A system according to claims 9, wherein the processor queries whether the first subscriber command should be locally stored in the memory.

11. A system according to claim 10, wherein the processor forwards the first subscriber command from the memory to the remote located component.

12. A system according to claim 9, wherein the processor queries whether information related to the second subscriber command should be locally stored in the memory.

13. A system according to claim 12, wherein if the information related to the second subscriber command is not to be locally stored, then the processor forwards the second subscriber command from the device.

14. A system according to claim 9, wherein the processor determines a result of the second subscriber command relative to a present context and the processor includes the result in the second subscriber command that is forwarded from the device.

15. A system according to claim 14, wherein in response to forwarding the result of the second subscriber command the processor receives a new video stream relative to the present context.

16. A system according to claim 9, wherein the processor concurrently locally stores information related to the second subscriber command in the memory.

17. A system according to claim 9, wherein after expiration of a pre-determined period of time, then the processor forwards information related to the first subscriber command from the device.

18. A system according to claim 9, wherein the processor receives targeted advertising based upon information related to the first subscriber command.

19. A system according to claim 9, wherein a set top box comprises the processor and the memory.

20. A system according to claim 9, wherein the interface is a remote control.
